(19) United States
(12) Patent Application Publication
(10) Pub. No.: US 2006/0177072 A1
(43) Pub. Date: Aug. 10, 2006

(54) Knowledge acquisition system, apparatus and process

(75) Inventor: Bruce Winston Ward, Mt Kuringai (AU)

Correspondence Address: AKERMAN SENTERFITT, P.O. BOX 3188, WEST PALM BEACH, FL, 33402-3188, US

(73) Assignee: I.P. Equities Pty Ltd, Mt Kuringai (AU)

(21) Appl. No.: 11/327,635

(22) Filed: Jan. 6, 2006

Related U.S. Application Data
(63) Continuation-in-part of application No. PCT/AU03/00876, filed on Jul. 8, 2003.

(51) Int. Cl. H04R 29/00

(52) U.S. Cl. 381/56; 381/384

(57) ABSTRACT

A system and method which utilise separate channels to provide learning related content to each ear. The sound must be delivered specifically to the correct ear, for example by headphones. The content in one form may be to deliver intellectual content to the right ear, and predominantly non-intellectual content such as music to the left ear. In another form the content in the one ear may be a time shifted version of the other ear content. Applicable especially to assist in training, pre-exam study and cramming.

### CROSS-REFERENCE TO RELATED APPLICATION

This application is a continuation-in-part of PCT Application No. PCT/AU2003/000876, filed Jul. 8, 2003, the entirety of which is incorporated by reference.

### TECHNICAL FIELD

The present invention relates to apparatus, systems and processes relating to enhancing specific forms of learning.

### BACKGROUND ART

Education and training are in many cases intended to deliver predetermined knowledge-based content to be learned, either sessionally over time, or in short units immediately. This is a requisite process before formal demonstration, either by testing or examination. In some cases self-testing regimes are used prior to formal demonstration.

Self testing is usually done by answering repetitive paper or digital questions. However, between the material being initially presented, and either self testing or formal examinations take place, an intermediate process of self-preparation, revision or cramming usually occurs.

This almost always involves a manual “read, note and repeat-write” process. The revision stage of learning is an area which has not been addressed in any systematic way.

While there are on the market thousands of old and new ways to study, learn, train and self-test, the inventor is unaware of any formalised method for undertaking the vital process of revision or cramming.

Many devices and processes have been proposed over the past 50 years in order to provide some enhancement or improvement in learning processes. One train of such processes purports to rely on neurophysiology, and in particular, certain aspects of the division of functions between the left and right hemispheres of the brain.

An example of this is so called phonics and similar systems, in which the retention of intellectual content is asserted to be enhanced by the simultaneous playing to both ears of certain types of music while learning. Another approach is so-called binaural wave training, and Lozanov accelerated learning which play identical sounds into both ears so as to attempt to bring the wave patterns in both hemispheres of the brain into synchrony and so attempt to promote knowledge acquisition.

Despite changes in teaching methods, there is still a need for students, whether at school, college, university or in training courses, to memorize material and to retain it in a working state. Students need to revise material studied as part of their course, and prepare for exams. This typically involves revision, re-writing and re-reading of notes, attempts at past papers, cover and check memorisation, and similar processes. The process of preparing for examinations is often referred to as cramming. There appears to have been no systematic attempt to provide a technological aid for cramming and pre-examination preparation, despite the clear need for such assistance by students.

It is an object of the present invention to provide an arrangement by which the learning of discrete information, particularly for cramming, training, exam study and similar purposes, can be enhanced.

### SUMMARY OF THE INVENTION

In a broad form, one aspect of the present invention relates to presenting information via a headset or similar arrangement to a user, in which the left and right ears are receiving entirely distinct information. The discrete left and right ear signals are not in the form of stereo sound, or with the intention of creating some common auditory effect. In one form, the right ear receives predominantly preselected intellectual content, whilst the left ear receives non intellectual content, for example music. The left ear content may be mixed with aural tags or labels, or include some intellectual content. In other implementations the left side is fed only with aural tags arranged in a patterned way. The left and right ear signals are in each implementation distinct signals.

According to one aspect, the present invention provides a system for assisting knowledge acquisition by a user, wherein audio data is presented via a separate left ear signal and right ear signal, wherein said right ear signal includes predominantly preselected intellectual content, and said left ear signal includes predominantly non intellectual content, and each ear is presented with only the channel intended for that ear.

According to another aspect, the present invention provides method of processing information for use in a system for assisting knowledge acquisition by a user, said process including the steps of providing a set of content; processing said content so as to produce a set of coaural data; and providing said coaural data to a user.

According to another aspect, the present invention an audio data set, adapted to be reproduced as a sound signal, the set including a separate left ear signal and right ear signal, wherein said right ear signal includes predominantly preselected intellectual content, and said left ear signal includes predominantly non intellectual content.

According to another aspect, the present invention A method of providing a processed audio file, including at least the steps of inputting, at a user location, text content; submitting said content to a remotely located server; processing said content to produce a corresponding audio file; and supplying said audio file.

Preferably, the content for each ear is generated by the desired information being processed to produce the two distinct sound channels.

It is theorised by the inventor that all intellectual information is processed by the brain's auditory systems, whether it is read or heard aloud. The brain processes, for example, a visually read word into a series of sounds, which are then recognised. It is well established that the different hemispheres of the brain process information in different and in some respects complimentary ways. In general terms, logical intellectual content is generally processed by the left-brain and intuitive, creative and emotional content by the right-brain.

It is further theorised by the inventor that the right and left brains when acquiring information to be learned by being either read or heard become distracted and so effectively unable to function cooperatively when content, particularly audible content, is boring, linear, monologic or monotonous.

It is the present inventor's contention that applying the proper sound stimulation to each hemisphere can assist in the acquisition of discrete information. The right ear is functionally connected to the left brain, so that intellectual information in the first instance (for example the names of the countries in South America) is supplied to the right ear. However, if the left ear is subjected to essentially the same stimulus, the right-brain may become distracted or more generally act to trigger a process to seek for more interesting input, and therefore detract from processing and effective revision and recall of the information being directed to the left brain. It is further believed that the timing and pace of the stimulation should be varied to assist in this process.

Accordingly, by providing a suitable discrete and appropriate stimulus to each ear, especially non-linear or varied input, the distraction impulse is reduced, and so neural information processing and recall is improved.

It is important that the ears receive the intended content, and not a mixture of left and right ear content delivered over, say, a speaker system in a room. The use of headphones or similar devices is preferred, in order to achieve the desired separate content.

This form of audio content will be referred to as coaural. For the purposes of the specification and claims, coaural means discrete unmixed monoaural content suitable for separate delivery to the left and right ears.

### BRIEF DESCRIPTION OF DRAWINGS

Various implementations of the present invention will now be described with reference to the accompanying figures, in which:

FIG. 1 is a general block diagram of one form of the inventive system;

FIG. 2 is more detailed block diagram providing more detail on the processing operations;

FIG. 3 is a block diagram illustrating signal synthesis;

FIG. 4 is a context diagram of one implementation of a method for converting intellectual content to a audio file; and

FIG. 5 is a timing graph.

### DETAILED DESCRIPTION OF THE DRAWINGS

The present invention will be described with reference to various practical implementations. However, it will be appreciated that the present invention is capable of various implementations, and the present alternatives are intended to be illustrative and not limiting.

The practical implementation in hardware of the present invention is most readily achieved using largely conventional audio and/or computing systems. However, the present invention is not particularly concerned with the specifics of the hardware and storage systems used, but with their functional arrangement and content.

One example of a typical implementation uses a personal device such as a video mpeg and/or mp3 player, mobile phone or personal digital assistant (PDA), which provides for a portable method of accepting user input, processing data as required and presenting the resulting output back to the user. However, it is to be understood that any such arrangement of hardware and/or software, including personal computers (PCs) and laptops, may be used to implement the system.

Another preferred implementation might utilise for example a computer, either fixed remote networked or freestanding, having the required audio MP3 or other audio capability with suitable storage and operating system with an audio headset outlet or wireless connection. The PC may be in a fixed location or a laptop or any personal or other audio visual device having these characteristics.

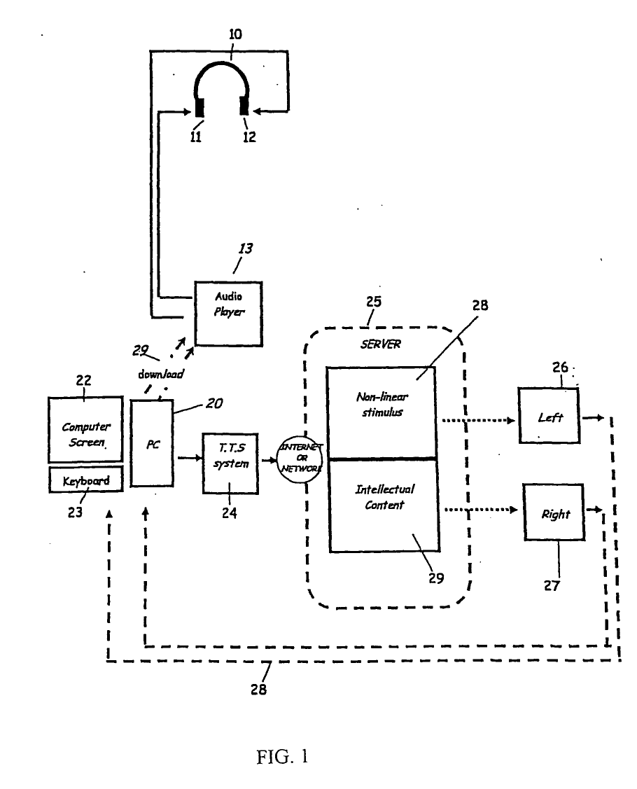

FIG. 1 illustrates the general arrangement of one embodiment of the present invention. Personal computer, generally designated as 20, includes a display 22 and keyboard 23. This allows for the desired intellectual content to be input. For example, the data may be text or a list of the names of the countries of South America. The data will be explained in more detail below.

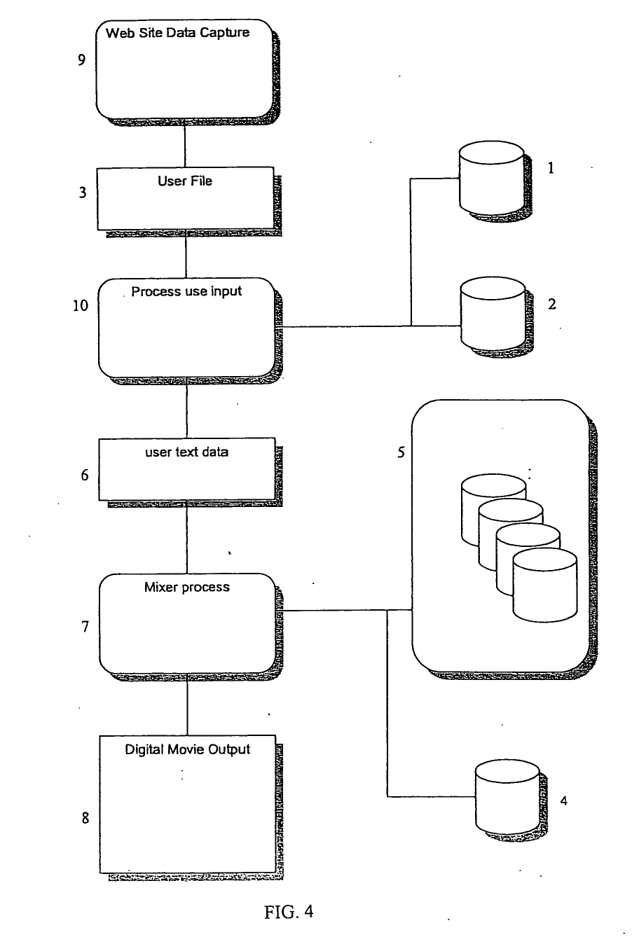

The data is then converted to speech, using a text to speech converter TTS 24. FIG. 4 describes in detail the operation of a typical text-to-speech. Typically, the text-to-speech system operates on the basis that the majority of processing is done at a remote server—the user, via a website or similar interface, provides and organises their desired text content, processing is performed at the server to generate the audio, and the file is returned to the user for use. In another embodiment local or inbuilt tts software and or hardware may be employed to engender the same effect

The remote server will in most cases of course need to provide significant processing ability, in order to handle the volume of users to be expected in an operative system of this type. The scale and speed required will be dependant upon the expected volume, as will be apparent to those skilled in the art. The system requirements of the database, voice engine and so forth as detailed below are specified by the respective suppliers.

In operation, the user provides a text file, which contains content, either in the form of prose or stamps, to be converted to digital audio files for the purpose of study and/or revision. Stamps typically include one or more marker headings, for example, ‘turbine’ and one or more items of intellectual content, for example, ‘30,000 rpm centrifugal’. An interface 9 for the user to enter and edit his or her revision material is preferably provided by means of a website or web based application. The user first identifies himself or herself to the system by providing an email address. The address is verified automatically by requiring the user to respond to an email initiated by the system. Once the user has been reliably identified, a new account and on-line identity are created.

The structure of the data provided by the user is typically as follows:

| Item | Description |
|---|---|
| Subject | Course name. Examples: Ancient History, Biology, etc. |
| Topic | General heading for a set of information. Each topic is |
| | associated with a subject. Examples: Athenian democracy, |
| | Trojan War, Battle of Marathon might be topics that are part of |
| | the subject Ancient History |
| Stamps | Individual fact to be learned. A stamp consists of a format with |
| | a label and an associated fact, which format excludes the need |
| | for questions and answers. Examples: “Demosthenes” = |
| | “Athenian orator time of Pericles”, “Napoleon invades Russia” = |
| | “1812, loses 450,000 men”, “Continental System” = “No trade |
| | with Britain, fails when Portugal, Russia refuse, 1804-07”. |

It is to be understood that a subject may contain many topics, while a topic will usually contain many stamps. It is in the nature of stamps that they consist of short fragments of text, and are not required to conform to norms such as sentence forms, complete grammar, etc.

However, the present invention may be employed with text generated by a local piece of software by a user and sent to the remote server. The present invention is adapted for use with relatively short fragments of text, rather than extensive tracts of material as a ‘read back’ mechanism.

At the user's end, only a standard Web browser is required such as Microsoft Internet Explorer, Firefox, Netscape, etc.

At the server, one implementation may use a Java J2EE application running on the server which will support the editing and organisational functions required. The users' data is typically stored on the same server in a database 1, using a database management system such as MySQL.

The user file 3 is stored in the database 1 according to the stamp structure discussed above. After editing, the user may choose one of these three actions:

1. Leave the editing session. It may be resumed later without loss of data.

2. Print out a usefully formatted paper image of the stamp content to facilitate off-line review.

3. Obtain an audio form of the stamp content suitable for audio review of the material.

The user information database 1 includes the following information in a typical user file 3:

User contact details,

User payment account details,

User order status,

Collection of input Subject/Topic/Stamp data sets, and

Binary file images of processed data/deliverable files after creation.

This data is used by the system to produce recorded CD-ROMs, which is one optional format by which users can obtain their audio output. Also, the text-to-speech engine 5 accesses the database 1 to fulfil on-line deliverable orders.

A digital dictionary word list 2, is derived from a standard dictionary, and is used 10 to verify the spelling of words and to improve pronunciation by the text-to-speech engine 5. In the present implementation, and Australian English dictionary is used. However, it will be understood that the present invention may be applied with any subject, speciality or language or dialect, with selection of appropriate dictionary files. The text file 6 is modified as needed to enable the engine of a text-to-speech engine 5 to correctly pronounce words in an audio file. For example, the word “yacht”, which if put directly through a text-to-speech engine, may yield a typical audio output as “Yat-cut” rather than “yot”. Processing the text file through a pronunciation dictionary results in said input text being rendered in the engine feed file as “yot” not “yacht”.

Word list 2 consists of pairs of in the format <English word, encoded pronunciation> and include entries numbering about 250,000. The format of the pronunciation encoding may typically be that of “L&H”, the name of a company whose technology provides a text-to-speech capability.

Word list 2 is also used to check the spelling of the words entered by the users. When a word does not appear on list 2, the user is warned. They may then verify that it is intended to be spelled the way presented, or they may change the word. The reason for this step is that the text-to-speech engine or software 5 needs to be able to identify the word to pronounce it properly, as misspellings will typically result in mispronunciations.

After spelling correction and scanning, the user text data 6 containing, for example, a number of stamps is ready to be used to generate speech. The format of the file at this point is plain ASCII text with special character sequences inserted to indicate pronunciation instructions where available, and plain text otherwise.

The encoded user text data 6 is the input to the final stage of processing, which results in a digitally encoded audio file in an industry-standard format, such as MPEG-1 Part 3 Layer 3 (or MPEG-1 Audio Layer 3), commonly referred to as MP3, which is suitable for listening on almost any PC, Macintosh or Linux system.

These files may be delivered to the user either by a direct download process, or by producing and shipping a physical CD or other storage device with the user's output on it, which is discussed in more detail below.

One use of the audio file is to combine the stream of digital speech data with music data 4 to generate a composite audio file.

In order to convert the user text data to audio file 8 as discussed above, a typical text-to-speech engine 5, such as the ScanSoft RealSpeak (version 4) product is utilised. There are many voices available with such product differing in language and gender. The system in a preferred form uses an Australian female voice, dubbed “Karen”, by ScanSoft.

The text-to-speech technology is built on a detailed analysis of the sounds encountered in spoken English. A vocal performer worked with ScanSoft/L&H for over a month to provide the sound content needed for the text-to-speech engine 5. Sound engineers dissected her recorded speech into short snippets of sound. These snippets are dynamically rewoven into high quality output file when rendering the user text data 6. The process also provides a reasonably natural intonation in the audio file 8 output.

It will be appreciated that such voices are commercially available from a variety of sources, and that any software or source producing any desired voice could be used, preferably one which is acceptable and intelligible to the particular user.

The audio file may be mixed with one of several canned music beat tracks 4 as required. The music beat tracks 4 are stored digitally and synchronized rhythmically with the text-to-speech output on a per-job basis. The timing depends on the intrinsic speed of the recorded sound and the requirements of the algorithmic rules applicable.

The output from this mixing processing is stored back in the database 1 for on-line delivery. Off-line CD-ROM delivery is supported by another server located along with the CD-ROM production equipment at a remote site.

The preferred implementation of the present invention provides audio file 8 output which carries the spoken content as an audio right channel and beat/music content in the audio left channel.

In the described implementation, TTS 24 is located at PC 20, but the TTS 24 may be located elsewhere, as discussed above.

This coaural data 21 is then sent back to the PC 20. This may be a real time or delayed process, as discussed above. The audio data may be in any suitable form. For example, it may be in the MP3 format widely used for portable music players, or any suitable analogue or digital format.

The coaural data 21 is preferably downloaded onto a medium suitable for an audio player 13. The audio player then reproduces the coaural signal as discrete signals to the left and right headphones 12, 11. Alternatively, the coaural signal could be directly output to speakers from PC 20.

The PC 20 could in a suitable implementation contain all the software necessary to compile the coaural signal. At an educational institution, a dedicated computer could be used to carry out the required processing and produce an audio signal on suitable media. Alternatively, essentially all functionality could be carried out at a website or in a networked remote server, with no substantial local software being required.

It is also contemplated that in addition to fully user defined content as described above, suitable pre-defined data could be made available for known subject matter. In this case, the step of producing the coaural data from the subject matter input would already have been performed when the user selects the desired data. The pre-defined data may, for example, be stored on a website or on storage media, and “State geography syllabus year 8” may be selected.

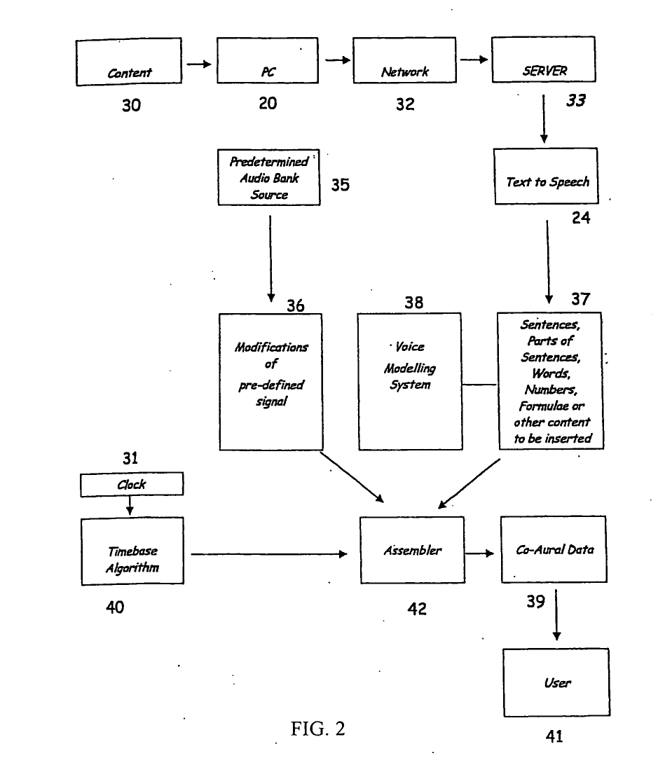

FIG. 2 describes in more detail the process by which the coaural data is produced. Content 30 is input to PC 20. This is then sent via network 32 to server 33. This may be via any suitable network, for example the internet, a dial up connection, or even an offline mechanism. The content is preferably input as text into PC 20. However, in alternative implementations the content could be any other input which the server 33 is adapted to process.

In this implementation, the text is converted to speech 24 at the server.

A voice modelling system 38, as discussed above, may be used to enhance, modulate and add expression and variety to TTS signal or other human or computer-generated inputs though server 33 as a means of increasing attention and engagement of left brain and/or inhibiting boredom or preventing distraction of right brain.

A content assembly processor 42 may select, using algorithms, the intellectual content 37 as pre-processed by modelling system 38 and assemble this with beats, music, silences, audible tags, null signals, pauses, or other features intended to add variety to the signal as a further means of inhibiting boredom or distraction of both right and left brains.

The above content and audible data is provided as a means of aiding co-location in the brain.

In a further embodiment the above audible content may link sets or subsets of audible data to visual user interface alphanumeric or visually text on the screen of PC 20 or in other places whereby both aural and visual data may be identified as connected by the brain as an aid to neurological processing and subsequent co-location in the brain.

In parallel, a bank of preselected audio material, beats, music 35 is used as the basis for the left ear signal. This material may be pre-prepared content, music, rhythmic sounds, or other data as will be described below in more detail. A suitable clock 39 and time base algorithm 40 provide a signal to ensure that the timing of the assembled signal is appropriate to the desired user outcome.

Responsive to the time base signal, the assembler 42 prepares the separate left and right ear signals as a composite but twin discrete channel dataset. The output signal 39 is then output to the user 40, via mechanisms discussed above.

It is emphasised that the coaural audio signal is entirely different from conventional audio signals delivered via headphones or the like. It is not a stereo or other signal which seeks to produce an illusion of depth or sound space in the user. The intention in general is that the signals for each ear be monaural, and that the content be quite distinct. It is not the same mono channel content in each ear. The nature of the signal will be more apparent from the example below, however, the separateness of the channels—that they are in fact two signals, not two aspects of one signal—is important to understanding the present invention.

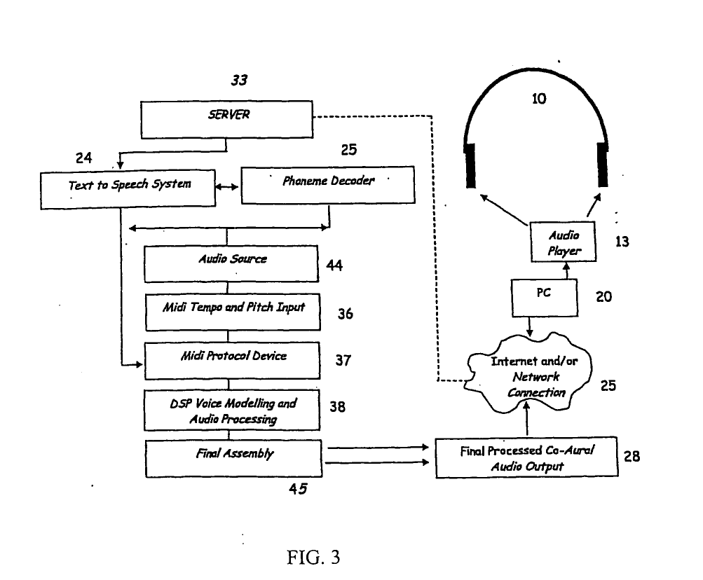

FIG. 3 describes in more detail one implementation of the audio processing system. Via a suitable network 25, the required content is supplied to server 33. The TTS 24 processes the text content as previously discussed. However, the output is also processed to detect phonemes at detector 25. Audio source 44 provides a basic human voice or text-converted signal or a computer generated voice signal, which is further converted and combined with the voice data. The purpose of this step is to enhance, modulate and add expression and variety to the voice signal as a means of increasing attention and engagement of left brain and/or inhibiting boredom or preventing distraction of the right brain.

In one embodiment, a voice tempo and pitch controller 36 inputs a rhythmic or arrhythmic time base in digital voice stream and in some versions balances this with decoded voice phonemes, feeding this stream to a music compiler 37 which establishes composite voice formats and digital base tracks on preparation for voice modelling in a DSP voice processor 38. The voice modeller 38 modifies the digital voice stream by imposing tone, modulation, voice style, voice gender, increases in pace and delivery, tonal and pitch variation to enhance and make the voice tracks fed to it more engaging to the users, adding interest and variety to prevent boredom and maintain brain engagement.

A further processor 45 may select from the several discrete streams of content and assemble this with silences, audible tags, null signals, or other features intended to add variety to the signal, and pass to processor 28.

The final processed co-aural audio input is sent back via the internet to the PC 20 for downloading and play as previously described.

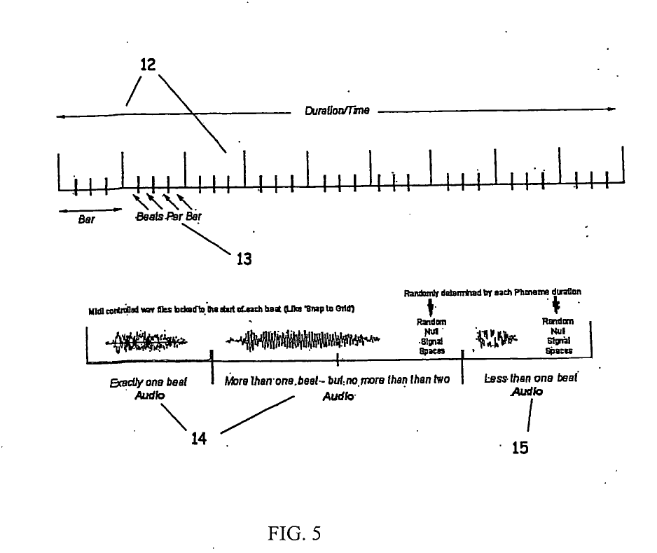

FIG. 5 shows representations of a time domain signal 12 of a type imposed by blocks 36 and 37 of FIG. 3, which time base indicates a typical 4 beats to the bar synchronised, for example, by midi time clock protocol or a snap to grid signal beats per bar assembly process as given schematically in FIG. 5 on the data stream running between units 36 and 38 of FIG. 3. The beat imposed is used to compile and insert melodic and/or staggered tags, beats, numbers, null spaces and other content in a stream of content to modulate delivery and content variation so as to enhance the signals and make these more engaging to the user.

FIG. 5 further extracts section 13 as a representation of oscilloscope screens shown at 14 and 15 where the magnified section 13 indicates subdivisions of beats and assembly of phoneme controlled voice as beats, music, numbers, null spaces and other content. The snap-to-grid or midi or other phoneme and beat assembly represented at 14 of FIG. 5 as controlled by units 36 and 37 of FIG. 3 above thereby assembles the mixed voice, space and music or beat. By snap to grid is meant that the time domain signals are locked to the beat structure.

The actual content to be provided in various implementations will now be described with reference to the following tables. That is, the time when the elements of the intellectual content are delivered to right ear, and the timing both relatively and absolute of the left ear channel. It is important to note that the best way to present particular content will vary with the nature of the content.

The timing of the stimuli may be presented in a variety of ways. In one form differing or regular time periods between each series of units of intellectual and non-intellectual content may be composed and delivered, which may vary in spacing either randomly, pseudo-randomly or in a predetermined pattern. In another embodiment regular spacings between each series of units of content may be used, or in other cases an irregular mixture of time spacing and signal insertion parameters.

The term beat signal is used in some of the examples below. A beat signal may be an audible code beat tone or marker forming a series whereby the brain is enabled to recognize both sets, or a sub-set of related content elements. This aids information uptake by the user by encouraging the information to be sited in a related or linked brain locus, thus assisting the recall of knowledge in sets or subsets of related information.

Each set of audio units may be vertically alternated within the same right or left channel field to provide variety, maintain the interest and reduce level of predictability, and so reduce boredom or distraction when listening to repeated content.

For the avoidance of doubt, it is emphasised that some intellectual content in the form of aural tags or headers or markers may be provided on either or both channels.

Some content may be best presented as a discrete list on the right ear side, and leading or trailing beats on the left ear side. This may be most appropriate for core subject information, such as lists, alphabets, times tables, names, dates, places, mathematical formulae, chemical formulae, geographic information, and complex arrangement listings such as biological organ mapping or aircraft instrument locations and the like. Table 1 below illustrates such an approach. The left ear channel has a zero or null signal mixed with beats or random audible tags inserted.

TABLE 1

| Audio | | | Middle | Typical right ear channel |
|---|---|---|---|---|
| Unit | Typical | Typical left ear channel content. | (zero infill | content. (In thIs case Intellectual |
| (Subset | periodicity | (In this case the non-intellectual | or signal | left brain content or knowledge to be |
| No) | (in seconds). | right brain content). | crossover) | acquired). |
| 1 | 0.0 | Aural Tag 1 | 0 | Battle of |
| 2 | 0.5 | Beat signal | 0 | 0 |
| 3 | 1.8 | 0 | 0 | Plev |
| 4 | 2.9 | Beat signal | 0 | 0 |
| 5 | 3.3 | 0 | 0 | na |
| 6 | 3.4 | space | 0 | 0 |
| 7 | 4.8 | 0 | 0 | eighteen |
| 8 | 5.6 | Tone signal, | 0 | 0 |
| 9 | 7.1 | 0 | 0 | seven |
| 10 | 8.2 | space | 0 | 0 |
| 11 | 9.5 | 0 | 0 | ty |
| 12 | 10.5 | Beat signal | 0 | 0 |
| 13 | 12.7 | space | 0 | 0 |
| 14 | 13.3 | 0 | 0 | Nine |

Note that there is zero cross over or mid field signal. This is the preferred mid field signal situation.

Another form of content delivery involves the use of “aural marker codes” or “mnemonic aural labels” on the right ear channel which are followed (i) by a discrete normally compiled or aurally-diverse trailing or reprised version of the same list or other information assemblage on the right channel interspersed with zero signal feed on one or both sides occurring at (pseudo)random spacing at time periods predetermined by experiment according to content type but typically between 0.1 secs and 5 secs. This method is outlined in Table TWO.

This example illustrates some additional techniques. A space or silence (null signal) occurs simultaneously in left channel and right channel units as exampled by lines 2 to 6 inclusive; lines 10 to 13 inclusive of Table 4. This has the intended function of allowing brain synapses and other neurology in the planum temporale of the brain and elsewhere time to either (a) neurologically reference knowledge unit to establish if that information unit is known and therefore not to be subject of further processing or (b) neurologically reflect on that information unit to establish if that unit is not known and therefore to be subject of further processing (uptake to memory). This refers to postulated neurological process known to the inventor as “reflecto-referencing” which this invention is intended to promote when listening to content for purposes of study, learning or revision.

This example has state space inserted to allow reflecto-referencing mixed with beats or random tags. In this example the left and right channels are spatially configured with a varied time base having zero signals interspersed with other let and right signals.

TABLE 2

| | Typical | | | |
|---|---|---|---|---|
| | periodicity | | | |
| Audio | seconds. | | | |
| unit | Time at | Typical left ear | Mid field | Typical right ear |
| No | completion | channel content | Content | channel content |
| 1 | 0.0 | Beat signal BB1 | 0 | 0 |
| 2 | 1.5 | 0 | 0 | Battle of Plevna |
| | | (Reflecto- | | |
| | | reference space) | | |
| 3 | 0.5 | 0 Beat signal BB2 | 0 | 0 |
| 4 | 2.5 | 0 (Reflecto- | 0 | eighteen seventy |
| | | reference space) | | |
| 5 | 0.5 | 0 Beat signal BB2 | 0 | 0 |
| 6 | 0.8 | 0 (Reflecto- | 0 | nine |
| | | reference space) | | |
| 7 | 1.3 | 0 (Reflecto- | 0 | 0 |
| | | reference space) | | |
| 8 | 0.6 | Beat signal BB2 | 0 | 0 |
| 9 | 2.9 | 0 | 0 | Russo-Turkish |
| 10 | 0.9 | 0 (Reflecto- | 0 | War |
| | | reference space) | | |
| 11 | 1.9 | 0 (Reflecto- | 0 | 0 |
| | | reference space) | | |
| 12 | 0.2 | 0 (Reflecto- | 0 | preceded |
| | | reference space) | | |
| 13 | 2.7 | 0 (Reflecto- | 0 | Crimea |
| | | reference space) | | |
| 14 | 3.3 | Beat signal BB3 | 0 | Next subset . . . |

In one preferred embodiment left channel right brain audible content either leads left channel or reprises left channel. In a second preferred embodiment non-audible content or “silent space” allows brain reflection or referencing. A mixture of both audible and non-audible right and left channel content may be employed. In a further preferred embodiment regular or irregular cadence, rhythm, beat, or musical or tonal variations may be employed in composing audible content in left channel. Other variations and possibilities for timing and content are possible within the general scope of the present invention.

In a few, otherwise normal, individuals all or parts of the functions of normal right and left brain are transposed. There is a conventional, simple user-administered test which allows this to be established and thus the headset channels reversed. Thus in these tables “right” means “left” and vice versa in the case of hemispherically transposed individuals.

It will be appreciated that the present invention could be implemented with a variety of audio hardware. In some implementations, the user may only select from a stored set of audio data. However, the method of the present invention enables this simple implementation. The content and optimum means of delivery is a matter which actual trials for each situation will establish. This is not a fully understood field.

1. A system for assisting knowledge acquisition by a user, wherein audio data is presented via a separate left ear signal and right ear signal, wherein said right ear signal includes predominantly preselected intellectual content, and said left ear signal includes predominantly non intellectual content, and each ear is presented with only the channel intended for that ear.

2. A system according to claim 1, wherein said separate signals are presented using earphones or a headset.

3. A system according to claim 1, wherein said right ear signal and left ear signal are selected and related so as to assist acquisition of specific knowledge selected by or for the user.

4. A system according claim 1, wherein the content of either or both signals has been processed and altered so as to enhance the non-predictability of the signal.

5. A system according to claim 4, wherein the left and right ear signals are time shifted relative to each other.

6. A system according to claim 1, wherein the right ear signal further includes music, beats, silences, audible tags or other non-intellectual material.

7. A system according to claim 1, wherein the left ear signal includes some intellectual content.

8. A method of processing information for use in a system for assisting knowledge acquisition by a user, said process including the steps of
Providing a set of content;
Processing said content so as to produce a set of coaural data;
Providing said coaural data to a user.

9. A method according to claim 8, wherein the coaural data comprises a right ear signal including predominantly preselected intellectual content, and a left ear signal including predominantly non intellectual content.

10. A method according to claim 9, wherein the data is provided on a storage medium.

11. A method according to claim 9, wherein the preselected intellectual content is predetermined and available for supply to a user.

12. A method according to claim 9, wherein the preselected intellectual content is produced using text content provided by the user.

13. A method according to claim 9, wherein said right ear signal and left ear signal are selected and related so as to assist acquisition of specific knowledge selected by or for the user.

14. A method according claim 9, wherein the content of either or both signals has been processed and altered so as to enhance the non-predictability of the signal.

15. A method according to claim 14, wherein the left and right ear signals are time shifted relative to each other.

16. A method according to claim 9, wherein the right ear signal further includes music, beats, silences, audible tags or other non-intellectual material.

17. A method according to claim 9 wherein the left ear signal includes some intellectual content.

18. An audio data set, adapted to be reproduced as a sound signal, the set including a separate left ear signal and right ear signal, wherein said right ear signal includes predominantly preselected intellectual content, and said left ear signal includes predominantly non intellectual content.

19. An audio data set according to claim 18, wherein the intellectual content is produced from text content supplied by a user.

20. An audio data set according to claim 18, wherein said right ear signal and left ear signal are selected and related so as to assist acquisition of specific knowledge selected by or for the user.

21. An audio data set according claim 20, wherein the content of either or both signals has been processed and altered so as to enhance the non-predictability of the signal.

22. An audio data set according to claim 21, wherein the left and right ear signals are time shifted relative to each other.

23. An audio data set according to claim 18, wherein the right ear signal further includes music, beats, silences, audible tags or other non-intellectual material.

24. An audio data set according to claim 22, wherein the left ear signal includes some intellectual content.

25. A method of providing a processed audio file, including at least the steps of inputting, at a user location, text content; submitting said content to a remotely located server; processing said content to produce a corresponding audio file; and supplying said audio file.

26. A method according to claim 25, wherein the audio file is in coaural format.

27. A method according to claim 26, wherein a right ear signal includes predominantly preselected intellectual content, and a left ear signal includes predominantly non intellectual content.

28. A method according to claim 25, wherein the user inputs said text content using a web interface.
